(19) United States
(12) Patent Application Publication
(10) Pub. No.: US 2008/0018793 A1
(43) Pub. Date: Jan. 24, 2008

(54) METHOD OF PROVIDING A HORIZONTAL ACTIVE SIGNAL AND METHOD OF PERFORMING A PIP FUNCTION IN A DIGITAL TELEVISION

(76) Inventors: Dong-Hoon Lee, Seoul (KR); Chang-Dae Park, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/612,827

(22) Filed: Dec. 19, 2006

(30) Foreign Application Priority Data
Jan. 4, 2006 (KR) 2006-846

(51) Int. Cl. H04N 5/45; H04N 9/74

(52) U.S. Cl. 348/581; 348/565

(57) ABSTRACT

A method of providing a horizontal active signal includes generating the horizontal active signal based on a line memory size and a time difference between a writing time that a variable scaler with a first operational clock frequency scabs an original video frame and writes a line of the scaled video frame into a line memory and a reading time that a display device with a second operational clock frequency reads the written line of the scaled video frame from the Hoe memory, so that a Hoe memory address does not collide when the variable scaler and the display device concurrently access the line memory, the first operational clock frequency being greater than the second operational clock frequency, and providing the generated horizontal active signal to the display device. Therefore, the method may reduce the line memory size and change a display resolution regardless of the line memory size.

### CROSS-REFERENCE TO RELATED APPLICATION

This application claims priority under 35 USC §119 to Korean Patent Application No. 2006-846 filed on Jan. 4, 2006, the contents of which are herein incorporated by reference in their entirety.

### BACKGROUND OF THE INVENTION

1. Technical Field

The present disclosure relates to a variable video scaler and, more particularly to a method of providing a horizontal active signal and a method of performing a Picture-In-Picture (PIP) function in a digital TV, and digital TVs performing the same.

2. Discussion of Related Art

Recently, as conventional image information such as video is expressed in digital form, methods for displaying the information have changed from a conventional analog method to a digital method. Consequently, display devices such as a digital TV and high definition TV (HDTV), which decode the received digital video data, have been rapidly developed.

FIG. 1 is a block diagram illustrating a configuration of a conventional digital TV 100.

Referring to FIG. 1, the digital TV 100 includes an antenna 110, a tuner 120, a decoder 130, a scaler 140, a line memory 150, and a display 160.

The digital TV 100 receives data associated with a plurality of broadcasting channels through the antenna 110 and selects a specific channel from among the broadcasting channels using the tuner 120 so as to receive digital data of the selected channel. The received digital data is decoded by the decoder 130, and the decoded data is scaled vertically and horizontally using the scaler 140.

The scaler 140 scales the decoded data line by line so as to store the scaled data into the line memory 150. The display 160 displays an image based on the scaled data, which were stored in the line memory 150.

FIG. 2 is a timing diagram illustrating an operation of a conventional scaler in a digital TV.

Referring to FIG. 2, the scaler 140 of FIG. 1 generates a vertical sync signal (V-SYNC), a horizontal sync signal (H-SYNC), a vertical line active signal (V-ACTIVE) and a horizontal active signal (H-ACTIVE) according to an operational step of the scaler 140.

The vertical sync signal (V-SYNC) is a signal indicating a start of a video frame, and the horizontal sync signal (H-SYNC) is a signal indicating a start of a line in the video frame. When the digital TV 100 displays a single video frame, the vertical sync signal (V-SYNC) is generated once and the horizontal sync signal (H-SYNC) is generated repeatedly, based on the number of lines.

When the vertical line active signal (V-ACTIVE) maintains a high level, the digital TV 100 displays a plurality of horizontal lines included in a high level section of the vertical line active signal (V-ACTIVE), and when the horizontal active signal (H-ACTIVE) maintains a high level, the digital TV 100 displays a plurality of pixels included m a high level section of horizontal active signal (H-ACTIVE).

The line memory 150 requires a capacity for storing the number of pixels included in a horizontal line of the display 160 because the line memory 150 provides image data by the line to the display 160.

As the resolution of the digital TV 100 has been increased, the number of pixels in a single Line has been increased. Additionally, a recent model of a digital TV provides a picture-in-picture (PIP) function, and the digital TV requires a plurality of line memories to perform the PIP function. As a result the necessary increase in line memory size may undesirably enlarge the size of the integrated circuits (IC) in the digital TV.

### SUMMARY OF THE INVENTION

Exemplary embodiments of the present invention are provided to substantially obviate one or more problems due to limitations and disadvantages of the related art described above.

In exemplary embodiments of the present invention, a method of providing a horizontal active signal capable of reducing a line memory size and changing a display resolution regardless of the line memory size is provided.

Exemplary embodiments of the present invention provide a method of performing a picture-in-picture (PIP) function in a digital TV capable of reducing a line memory size and changing a display resolution regardless of the line memory size.

In exemplary embodiments of the present invention, a digital TV capable of reducing a line memory size and changing a display resolution regardless of the line memory size is provided.

In exemplary embodiments of the present invention, a digital TV performing a PIP function capable of reducing a line memory size and changing a display resolution regardless of the line memory size is provided.

In exemplary embodiments of the present invention, a method of providing a horizontal active signal includes generating the horizontal active signal based on a line memory size and a time difference between a writing time that a variable scaler with a first operational clock frequency scales an original video frame and writes a line of the scaled video frame into a line memory and a reading time that a display device with a second operational clock frequency reads the written line of the scaled video frame from the line memory, so that a line memory address does not collide when the variable scaler and the display device concurrently access the line memory, the first operational clock; frequency being greater than the second operational clock frequency, and providing the generated horizontal active signal to the display device.

Generating the horizontal active signal may include determining a scaling factor based on a number of pixels in a line of the original video frame and a number of pixels in the line of the scaled video frame, generating the horizontal active signal at a predetermined system time when the scaling factor is less than or equal to 1, and generating the horizontal active Signal based on the scaling factor and the line memory size when the scaling factor is greater than 1.

Generating the horizontal active signal based on the scaling factor and the line memory size may include calculating a scaler time by dividing the number of pixels in the line of the original video frame by the first operational clock frequency, calculating a display time by dividing the number of pixels in the line of the scaled video frame by the second operational clock frequency, calculating a time difference between the scaler time and the display time, and generating the horizontal active signal based on a value by multiplying the time difference between the scaler time and the display time by the second operational clock frequency.

Generating the horizontal active signal based on the scaling factor and the line memory size may include searching a database for a generation time of the horizontal active signal based on the scaling factor and the line memory size, and generating the horizontal active signal at the searched generation time.

In exemplary embodiments of the present invention, a method of performing a picture-in-picture (PIP) function in a digital TV may include generating a first horizontal active signal based on a first line memory size and a time difference between a writing time that a first variable scaler with a first operational clock frequency scales a first original video frame and writes a line of the first scaled video frame into a first line memory and a reading time that a display device with a third operational clock frequency reads the written line of the first scaled video frame from the first line memory, so that a first line memory address does not collide when the first variable scaler and the display device concurrently access the first line memory, the first operational clock frequency being greater than the third operational clock frequency, generating a second horizontal active signal based on a second line memory size and a time difference between a writing time that a second variable scaler with a second operational clock frequency scales a second original video frame and writes a line of the second scaled video frame into a second line memory and a reading time that a display device reads the written line of the second scaled video frame from the second line memory, so that a second line memory address does not collide when the second variable scaler and the display device concurrently access the second line memory, the second operational clock frequency being greater than the third operational clock frequency, and performing a PIP function based on the first horizontal active signal and the second horizontal active signal.

Generating the first horizontal active signal may include determining a first scaling factor based on a number of pixels in a line of the first original video frame and a number of pixels in the line of the first scaled video frame, generating the first horizontal active signal at a predetermined system time when the first scaling factor is less than or equal to 1, and generating the first horizontal active signal based on the first scaling factor and the first line memory size when the first scaling factor is greater than 1.

Generating the first horizontal active signal based on the first scaling factor and the first line memory size may include calculating a first scaler time by dividing a number of pixels in the line of the first original video frame by the first operational clock frequency, calculating a first display time by dividing the number of pixels in the line of the first scaled video frame by the third operational clock frequency, calculating a time difference between the first scaler time and the first display time, and generating the first horizontal active signal based on a value by multiplying the time difference between the first scaler time and the first display time by the third operational clock frequency.

Generating the first horizontal active signal based on the first scaling factor and the first line memory size may include searching a first database for a generation time of the first horizontal active signal based on the first scaling factor and the first line memory size, and generating the first horizontal active signal at the searched generation time.

Generating the second horizontal active signal may include determining a second scaling factor based on a number of pixels in a line of the second original video frame and a number of pixels in the line of the second scaled video frame, generating the second horizontal active signal at a predetermined system time when the second scaling factor is less than or equal to 1, and generating the second horizontal active signal based on the second scaling factor and the second line memory size when the second scaling factor is greater than 1.

Generating the second horizontal active signal based on the second scaling factor and the second line memory size may include calculating a second scaler time by dividing a number of pixels in the line of the second original video frame by the second operational clock frequency, calculating a second display time by dividing the number of pixels in the line of the second scaled video frame by the third operational clock frequency, calculating a time difference between the second scaler time and the second display time, and generating the second horizontal active signal based on a value by multiplying the time difference between the second scaler time and the second display time by the third operational clock frequency.

Generating the second horizontal active signal based on the second scaling factor and the second line memory size may include searching a second database for a generation time of the second horizontal active signal based on the second scaling factor and the second line memory size, and generating the second horizontal active signal at the searched generation time.

In exemplary embodiments of the present invention, a digital TV includes a line memory configured to store a line of a scaled video frame, a display device configured to read the line of the scaled video frame when the display device receives a horizontal active signal, and a variable scaler configured to generate the horizontal active signal based on a line memory size and a time difference between a writing time that the variable scaler with a first operational clock frequency scales an original video frame and writes the line of the scaled video frame into the line memory and a reading time that the display device with a second operational clock frequency reads the written line of the scaled video frame from the line memory, so that a line memory address does not collide when the variable scaler and the display device concurrently access the line memory, the first operational clock frequency being greater than the second operational clock frequency.

The variable scaler may determine a scaling factor based on a number of pixels in a line of the original video frame and a number of pixels in the line of the scaled video frame, may generate the horizontal active signal at a predetermined system time when the scaling factor is less than or equal to 1, and may generate the horizontal active signal based on the scaling factor and the line memory size when the scaling factor is greater than 1.

The variable scaler may calculate a scaler time by dividing a number of pixels in the line of the original video frame by the first operational clock frequency, may calculate a display time by dividing the number of pixels in the line of the scaled video frame by the second operational clock frequency, may calculate a time difference between the scaler time and the display time, and may generate the horizontal active signal based on a value by multiplying the time difference between the scaler time and the display time by the second operational clock frequency.

The variable scaler may search a database for a generation time of the horizontal active signal based on the scaling factor and the line memory size, and may generate the horizontal active signal at the searched generation time.

In an exemplary embodiment, the line memory size may be smaller than a memory size storing the number of pixels in the line of the original video frame.

In exemplary embodiments of the present invention, a digital TV performing a picture-in-picture (PIP) function includes a first line memory configured to store a line of a first scaled video frame, a second line memory configured to store a line of a second scaled video frame, a PIP selector configured to selectively read the line of the first scaled video frame or the line of the second scaled video frame based on a first horizontal active signal and a second horizontal active signal, a display device configured to display the selected line, a first variable scaler configured to generate the first horizontal active signal based on a first line memory size and a time difference between a writing time that the first variable scaler with a first operational clock frequency scales a first original video frame and writes the line of the first scaled video frame into the first line memory and a reading time that the display device with a third operational clock frequency reads the written line of the first scaled video frame from the first line memory, so that a first line memory address does not collide when the first variable scaler and the display device concurrently access the first line memory, the first operational clock frequency being greater than the third operational clock frequency, and a second variable scaler configured to generate the second horizontal active signal based on a second line memory size and a time difference between a writing time that the second variable scaler with a second operational clock frequency scales a second original video frame and writes the line of the second scaled video frame into the second line memory and a reading time that the display device with the third operational clock frequency reads the written line of the second scaled video frame from the second line memory, so that a second line memory address does not collide when the second variable scaler and the display device concurrently access the second line memory, the second operational clock frequency being greater than the third operational clock frequency.

The first variable scaler may determine a first scaling factor based on a number of pixels in a line of the first original video frame and a number of pixels in the line of the first scaled video frame, may generate the first horizontal active signal at a predetermined system time when the first scaling factor is less than or equal to 1, and may generate the first horizontal active signal based on the first scaling factor and the first line memory size when the first scaling factor is greater than 1.

The first variable scaler may calculate a first scaler time by dividing a number of pixels in the line of the first original video frame by the first operational clock frequency, may calculate a first display time by dividing the number of pixels in the line of the first scaled video frame by the third operational clock frequency, may calculate a time difference between the first scaler time and the first display time, and may generate the first horizontal active signal based on a value by multiplying the time difference between the first scaler time and the first display time by the third operational clock frequency.

The first variable scaler may search a first database for a generation time of the first horizontal active signal based on the first scaling factor and the first line memory size, and may generate the first horizontal active signal at the searched generation time.

For example, the first line memory size may be smaller than a memory size of storing the number of pixels in the line of the first original video frame.

The second variable scaler may determine a second scaling factor based on a number of pixels in a line of the second original video frame and a number of pixels in the line of the second scaled video frame, may generate the second horizontal active signal at a predetermined system time when the second scaling factor is less than or equal to 1, and may generate the second horizontal active signal based on the second scaling factor and the second line memory size when the second scaling factor is greater than 1.

The second variable scaler may calculate a second scaler time by dividing a number of pixels in the line of the second original video frame by the second operational clock frequency, may calculate a second display time by dividing the number of pixels in the line of the second scaled video frame by the third operational clock frequency, may calculate a time difference between the second scaler time and the second display time, and may generate the second horizontal active signal based on a value by multiplying the time difference between the second scaler time and the second display time by the third operational clock frequency.

The second variable scaler may search a second database for a generation time of the second horizontal active signal based on the second scaling factor and the second line memory size, and may generate the second horizontal active signal at the searched generation time.

In an exemplary embodiment, the second line memory size may be smaller than a memory size storing the number of pixels in the line of the second original video frame.

Therefore, the method may reduce the line memory size and change a display resolution regardless of the line memory size.

### BRIEF DESCRIPTION OF THE DRAWINGS

Exemplary embodiments of the present invention will be understood in more detail from the following descriptions taken in conjunction with the attached drawings.

FIG. 1 is a block diagram illustrating a configuration of a conventional digital TV.

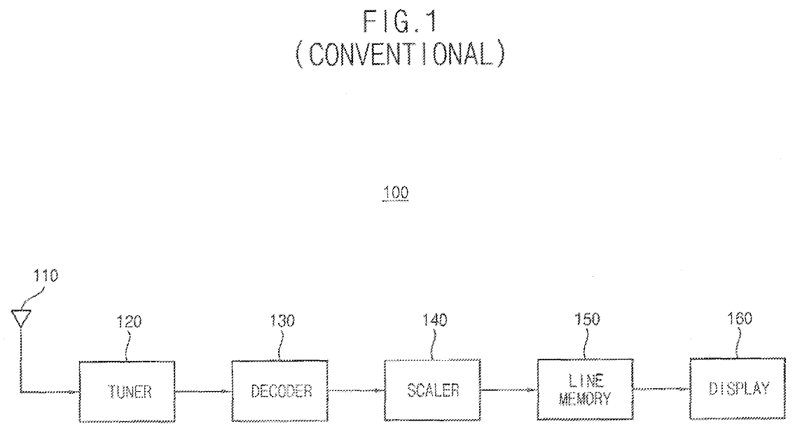

FIG. 2 is a timing diagram illustrating an operation of a conventional scaler in a digital TV.

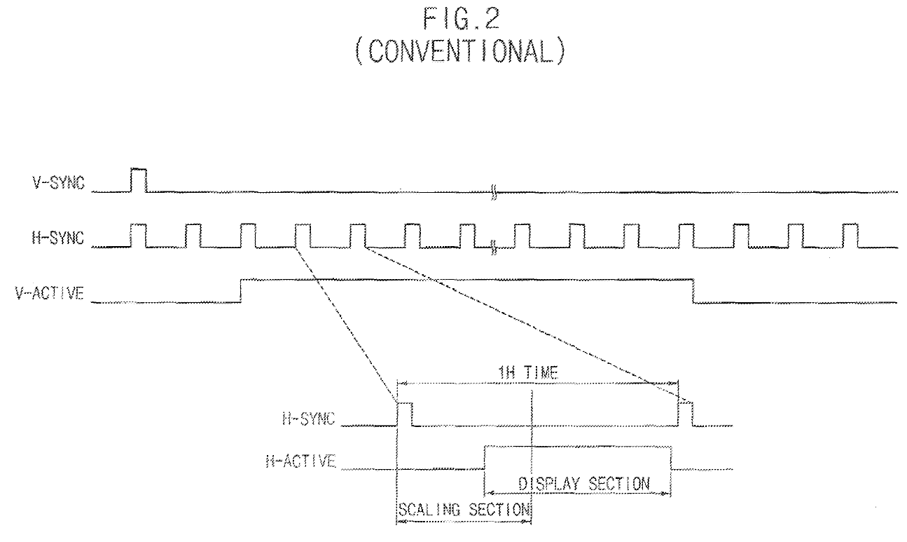

FIG 3 is a block diagram illustrating a digital TV according to an exemplary embodiment of the present invention.

FIG. 4 is a block diagram illustrating the variable scaler of the digital TV in FIG. 3.

FIG. 5 is a table illustrating a time that the horizontal scaler and the display write and read the digital video data to and from the line memories having a different size, respectively.

FIG. 6 is a flow chart illustrating an operation of the horizontal line active signal generator in FIG. 5.

FIG. 7 is a timing diagram illustrating a procedure of outputting a single horizontal line by the variable scaler in FIG. 3.

FIG. 8 is a block diagram illustrating a configuration of a digital TV performing a picture-in-picture (PIP) function according to an exemplary embodiment of the present invention.

FIG. 9 is a block diagram illustrating a PIP selector in FIG. 8.

FIG. 10 is a timing diagram illustrating a procedure of outputting a single line of the main frame and the sub frame in the digital TV.

### DETAILED DESCRIPTION OF EXEMPLARY EMBODIMENTS

The present invention is described more fully hereinafter with reference to the accompanying drawings, in which exemplary embodiments of the invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art.

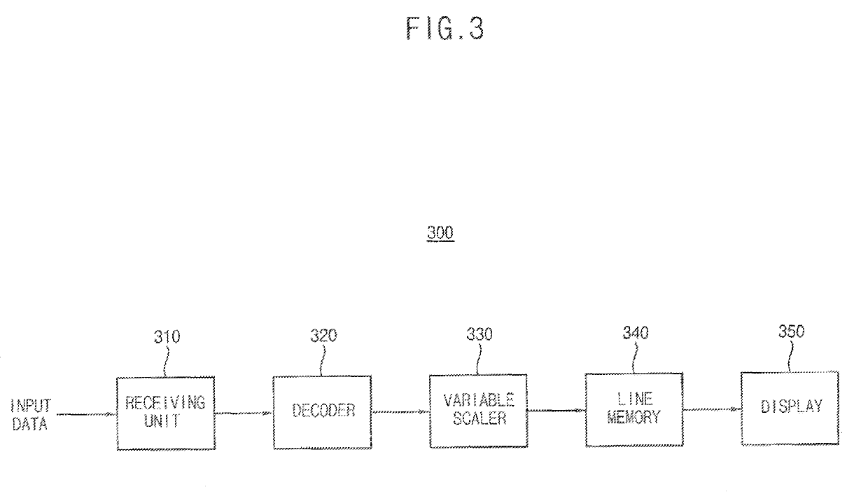

FIG. 3 is a block diagram illustrating a digital TV 300 according to an exemplary embodiment of the present invention.

Referring to FIG. 3, the digital TV 300 includes a receiving unit 310, a decoder 320, a variable scaler 330, a Sine memory 340 and a display 350.

The receiving unit 310 selects a single channel from among a plurality of wired/wireless channels so as to receive the digital video data of the selected channel. For example, the wired/wireless channels may be formed through a cable, the Internet, a satellite broadcasting, a terrestrial broadcasting, and the like.

The decoder 320 decodes the received digital video data by a predetermined decoding method corresponding to the encoding method, such as a moving picture expert group (MPEG) standard, by which the received digital video data had been encoded.

The variable scaler 330 scales the received digital video data and outputs a vertical sync signal (V-SYNC), a horizontal sync signal (H-SYNC), a vertical line active signal (V-ACTIVE) and a horizontal active signal (H-ACTIVE) according to an operational step of the variable scaler 330

The line memory 340 stores the scaled digital video data outputted from the variable scaler 330. The variable scaler 330 writes the digital video data into the line memory 340 and the display 350 reads the written data from the line memory 340.

The display 350 displays the scaled digital video data stored in the line memory 340 according to the vertical sync signal (V-SYNC), the horizontal sync signal (H-SYNC), the vertical line active signal (V-ACTIVE) and the horizontal active signal (H-ACTIVE) generated by the variable scaler 340.

The size of the line memory 340 may be reduced by adjusting an output time of the horizontal active signal (H-ACTIVE). That is, the size of the line memory 340 may be reduced by using a time difference between the time point that the variable scaler 330 writes the digital video data into the line memory 340 and the time point that the display 350 reads the written digital video data from the line memory 340. A detailed operation of the variable scaler 330 will be described hereinbelow.

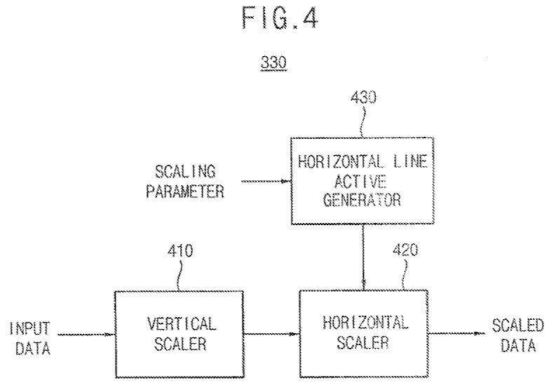

FIG. 4 is a block diagram illustrating the variable scaler of the digital TV shown in FIG. 3.

Referring to FIG. 4, the variable scaler 330 includes a vertical scaler 410, a horizontal scaler 420 and a horizontal line active signal generator 430.

The vertical scaler 410 generates the vertical sync signal (V-SYNC) indicating a start of a single video frame and the vertical line active signal (V-ACTIVE) indicating a display section of the single video frame.

The horizontal scaler 420 may generate the horizontal sync signal (H-SYNC) indicating a start of a single line in the video frame and the horizontal active signal (H-ACTIVE) indicating a display section of the single line.

When the display 350 displays the single video frame, the variable scaler 330 may generate a single vertical sync signal (V-SYNC) and a plurality of the horizontal sync signals (H-SYNC).

After the horizontal scaler 410 outputs the horizontal sync signal (H-SYNC), the horizontal line active signal generator 430 determines the output time of the horizontal active signal (H-ACTIVE). That is, the horizontal line active signal generator 430 determines a time point that the display 350 reads the single line from the line memory 340.

The operation of the variable scaler 330 of FIG. 4 will be described in the following.

The vertical scaler 410 generates the vertical sync signal (V-SYNC) to notify the start of the single video frame to the display 350 and generates the vertical active signal (V-ACTIVE) to notify a display section of the single video frame to the display 350. The horizontal scaler 420 generates the horizontal sync signal (H-SYNC) to inform the display 350 of the stint of the single line in the video frame and then writes the digital video data to the line memory 340.

The horizontal scaler 420 writes the digital video data, to the line memory 340 in response to the horizontal sync signal (H-SYNC), but the display 350 does not read the digital video data from the line memory 340 before the horizontal active signal (H-ACTIVE) occurs, because an address of the line memory 340 may collide if the horizontal scaler 420 and the display 350 concurrently access the line memory 340.

The horizontal line active signal generator 430 determines the output time of the horizontal active signal (H-ACTIVE). That is, the horizontal line active signal generator 430 determines the time point that the address of the line memory 340 will not collide even when the horizontal scaler 420 and the display 350 concurrently access the line memory 340.

After the horizontal line active signal generator 430 outputs the horizontal active signal (H-ACTIVE), the horizontal scaler 420 and the display 350 write and read the digital video data to and from the line memory 340 of FIG. 3, respectively.

A generation method for the horizontal active signal (H-ACTIVE) by the horizontal line active signal generator 430 will be described hereinbelow.

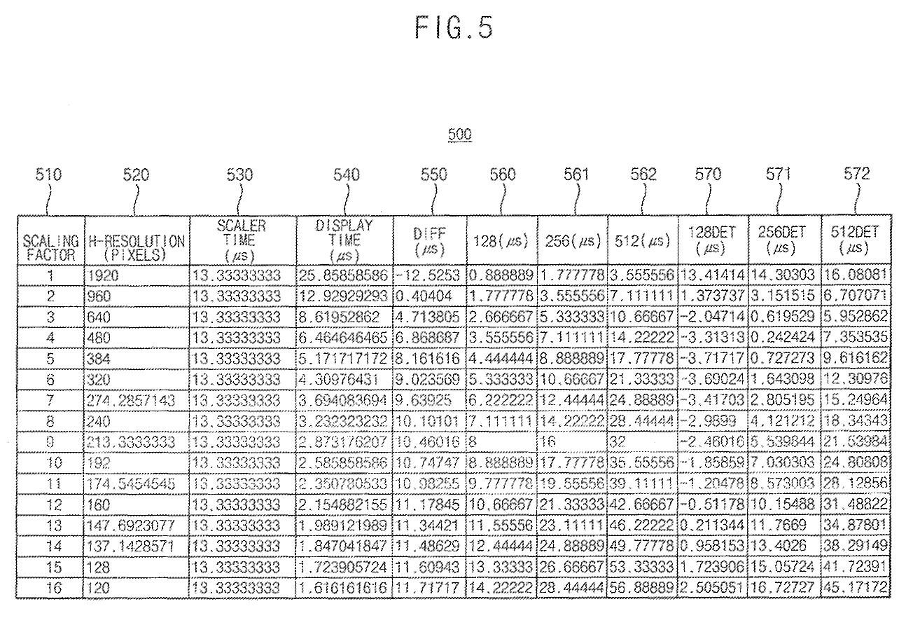

FIG. 5 is a table 500 illustrating a time that the horizontal scaler and the display write and read the digital video data to and from line memories of various sizes.

The table 500 in FIG. 5 is based on an assumption that the maximum number of pixels in a single horizontal line in the digital TV corresponds to ‘1920’, a clock of the variable scaler 330 operates at 144 MHz and a clock of the display 350 operates at 74.25 MHz,

Referring to FIG. 5, columns of the table 500 indicate a scaling factor 510, a horizontal resolution 520, a scaler time 530, a display time 540, a time difference 550, first, second, and third sizes of the line memories 560 to 562, respectively, and first, second and third determination time differences 570 to 572, respectively.

The scaling factor 510 is a ratio of the pixels in a line of an original video frame to the pixels in a line of a displaying video frame.

The horizontal resolution 520 corresponds to the number of pixels displayed by the display 350. Generally, the horizontal resolution of the digital TV 300 may be selected from among a plurality of predetermined values.

The scaler time 530 indicates a time for scaling the pixels in the horizontal output line on the horizontal scaler 420. That is, the scaler time 530 indicates a time for which the horizontal scaler 420 writes the pixels, corresponding to the horizontal resolution 520, into the horizontal scaler 420.

The display time 540 indicates a time for outputting the pixels written in the horizontal scaler 420 to the display 350. That is, the display time 540 indicates a time for which the display 350 reads the pixels, corresponding to the horizontal resolution 520, from the line memory 340.

The time difference 550 corresponds to a time difference between the scaler time and the display time. When the time difference 550 is smaller than ‘0,’ the line memory 340 may not be empty even if the variable scaler 330 and the display 350 concurrently access the line memory 340, because the operational speed of the variable scaler 330 may be faster than that of the display 350. When the time difference 550 is greater than ‘0’, however, line memory 340 may be empty when the variable scaler 330 and the display 350 concurrently access the line memory 340, because the operational speed of the variable scaler 330 may be slower than that of the display 350. Therefore, when the value of the time difference 550 is greater than ‘0,’ the variable scaler 330 writes the digital video data having an adequate size to the line memory 340 before the display begins to read the digital video data from the line memory 340 and as a result, the line memory 340 may be prevented from being empty.

The first, second, and third sizes 560, 561 and 562 of the line memory respectively correspond to a time, in the variable scaler 330, for writing the digital video data to the line memory 340 having a size for storing ‘128’, ‘256’ and ‘512’ pixels For example, the second size 561 of the line memory indicates the time for writing 256 pixels to the line memory 340 having a size for storing the 256 pixels before the display 350 reads the written pixels from the line memory 340. The line memory 340 having a size for storing 256 pixels is necessary to prevent the line memory 340 from being emptied, even when the variable scaler 330 and the display 350 concurrently access the line memory 340.

The first to third determination time differences 570, 571 and 572 indicate a time difference between the first to third sizes 560, 561 and 562 of the line memories and the time difference 550, respectively. That is, the first to third determination time differences 570, 571 and 572 respectively indicate a time difference between the time for writing the digital video data to the line memory 340 having sizes for respectively storing 128, 256, and 512 pixels and the time difference 550. A respective value of the first to third determination time differences 570, 571 and 572 is smaller than ‘0’ in the case that the line memory 340 may be empty, and the variable scaler 330 and the display 350 concurrently access the line memory 340 after respectively storing to the line memory 340 the digital video data corresponding to the first to third sizes of the line memory 560 to 562. That is, when the respective value of the first to third determination time differences 570, 571 and 572 is smaller than ‘0,’ an error occurs because the line memory 340 may be empty.

On the other hand, the respective value of the first to third determination time differences is greater than ‘0’ when the line memory 340 may not be empty, or when the variable scaler 330 and the display 350 concurrently access the line memory 340 after respectively storing the digital video data to the line memory 340 corresponding to the first to third sizes of the line memories 560 to 562.

For example, a first row in which the scaling factor corresponds to ‘1’ and a second row in which the scaling factor corresponds to ‘8’ will be described hereinafter.

When the scaling factor 510 corresponds to ‘1’, the time difference 550 has a negative value, hence a size of the line memory 340 does not have much effect, because the operational speed of the variable scaler 330 is faster than that of the display 350.

When the value of the scaling factor 510 corresponds to ‘8’, however, the time difference 550 has a positive value, hence an adequate size of the fine memory 340 may be required.

Referring to the column of the first determination time difference 570, the first determination time difference 570 has a negative number, hence the line memory 340 may be empty when the variable scaler 330 and the display 350 concurrently access the line memory 340, even after storing the digital video data to the line memory 340 having the first, size of the line memory 560. Therefore, when the value of the scaling factor 510 corresponds to ‘8’ and a size of the line memory 340 corresponds to the first size of the line memory 560, an error may occur.

Referring to a column of the second to third determination time differences 571 to 572, however, a respective value of the second to third determination time differences 571 to 572 has a positive number, hence the line memory 340 may not be empty when the variable scaler 330 and the display 350 concurrently access the line memory 340.

When the respective value of the first to third determination time differences 570 to 572 is greater than ‘0’, determining the output time of the horizontal active signal (H-ACTIVE) is required. A detailed method of determining the output time of the horizontal active signal (H-ACTIVE) will be described hereinbelow.

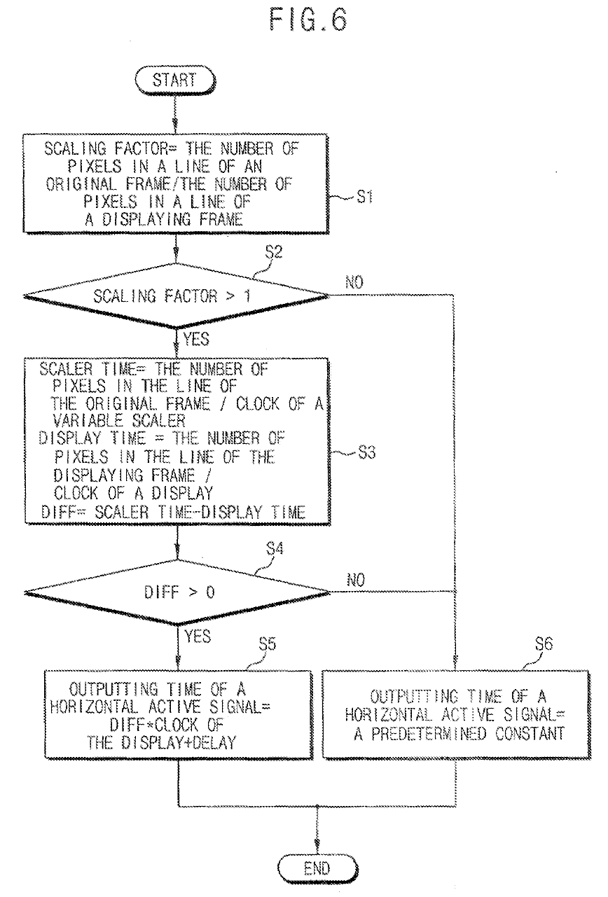

FIG. 6 is a flow chart illustrating an operation of the horizontal line active signal generator shown in FIG. 4.

The horizontal line active signal generator shown at 430 in FIG. 4 determines the scaling factor that is determined by dividing the number of pixels in the horizontal input line into the number of pixels in the horizontal output line (Step S1). When a user changes a horizontal resolution, the scaling factor may be changed.

The horizontal line active signal generator 430 determines whether the scaling factor is greater than ‘1’. That is, the horizontal line active signal generator 430 determines whether an image outputted from the display 350 is scaled down or not.

When the scaling factor is greater than ‘1’, the horizontal line active signal generator 430 calculates the scaler time 530, the display time 540 and a time difference 550 as represented in FIG. 5.

The scaler time 530 is determined by dividing the number of pixels in the horizontal input line by the clock of the variable scaler 330 shown in FIG. 3. That is, the scaler time 530 indicates a time for outputting the pixels from the horizontal output fine on the horizontal scaler 420 to the line memory 340.

The display time 540 is determined by dividing the number of pixels in the horizontal input line by the clock of the display 350. In this exemplary embodiment the display time 540 indicates the time for reading the pixels in the horizontal output line from the line memory 340 on the display 350.

The time difference 550 is determined by subtracting the display time 540 from the scaler time 530. That is, the time difference 550 indicates an operational speed difference between the variable scaler 330 and the display 350.

The horizontal line active signal generator 430 determines whether the time difference 550 is greater than ‘0’ (Step S4) or not. The time difference 550 becomes greater than ‘0,’ when the line memory 340 may be empty and the variable scaler 330 and the display 350 concurrently access the line memory 340, because the operational speed of the variable scaler 330 may be slower than that of the display 350. Therefore, when the value of the time difference 550 is greater than ‘0’, the variable scaler 330 previously writes the digital video data having an adequate size to the fine memory 340 and, as a result the line memory 340 may be prevented from being empty.

When the time difference 550 is greater than ‘0,’ the horizontal line active signal generator 430 determines the output time of the horizontal active signal (H-ACTIVE) to output the determined horizontal active signal (H-ACTIVE), the output time indicating a tune point that the address of the line memory 340 does not collide even when the horizontal scaler 420 and the display 350 concurrently access the line memory 340.

When the time difference is greater than ‘0,’ the output time of the horizontal active signal (H-ACTIVE) is determined by the following equation 1 (Step S5).

H_ACTIVE_OFFSET=DIFF*DISPLAY_CLOCK+DELAY [Equation 1]

H_ACTIVE_OFFSET indicates the output time of the horizontal active signal (H-ACTIVE). DIFF indicates a value that subtracts the display time 540 from the scaler time 530. DISPLAY_CLOCK indicates the clock of the display 350. DELAY indicates a system constant.

When the scaling factor is less than or equal to ‘1’ or the time difference 550 is less than or equal to ‘0,’ the output time of the horizontal active signal (H-ACTIVE) is determined as a predetermined constant (Step S6). The predetermined constant must be small so as not to collide even when the horizontal scaler 420 and the display 350 concurrently access the line memory 340. In this exemplary embodiment, a writing speed of the variable scaler 330 is faster than a reading speed of the display 350.

A calculation method of values represented in the respective columns 510 through 572 and a calculation method of the output time of the horizontal active signal (H-ACTIVE) are described above. The values represented in the respective columns 510 through 572 and the output time of the horizontal active signal (H-ACTIVE), however, may be stored into a database in lieu of being dynamically determined according to the scaling factor 510.

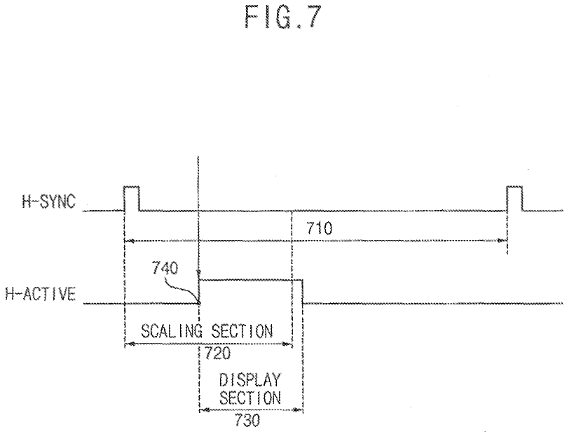

FIG. 7 is a timing diagram illustrating a procedure of outputting a single horizontal line by the variable scaler shown at 330 in FIG. 3.

Referring to FIG. 7, the procedure of outputting the single horizontal Sine by the variable scaler 330 is divided into a horizontal line section 710, a scaling section 720, a display section 730 and the output time of the horizontal active signal (H_ACTIVE_OFFSET).

The horizontal line section 710 indicates a section that the display 350 outputs a single horizontal line of a frame. The horizontal sync signal (H-SYNC) outputted from the horizontal scaler 420 indicates an end of a previous line and a start of a current line in the frame.

The scaling section 720 indicates a section that the variable scaler 330 scales a single line of a frame. That is, the scaling section 720 indicates a section that the variable scaler 330 writes the single line into the line memory 340 of FIG. 3.

The display section 730 indicates a section that the display 350 outputs a single line of the video frame. That is, the display section 730 indicates a section that the display 350 reads the single line from the line memory 340.

The output time of the horizontal active signal (H_ACTIVE_OFFSET) 740 indicates a value determined by Equation 1 set forth above. That is, the output time of the horizontal active signal (H_ACTIVE_OFFSET) 740 indicates the time point that the address of the line memory 340 does not collide even when the horizontal scaler 420 and the display 350 concurrently access the line memory 340.

A procedure of outputting a single horizontal line by the variable scaler 330 of FIG. 3 is described as follows.

The horizontal sync signal (H-SYNC) outputted from the horizontal scaler 420 of FIG. 4 notifies a start of a current line in a frame to a display 350.

The display 350 reads the current line from the line memory 340 when the horizontal active signal (H-ACTIVE) corresponds to a high level. The output, time of the horizontal active signal (H_ACTIVE_OFFSET) is determined by the horizontal line active signal generator 430.

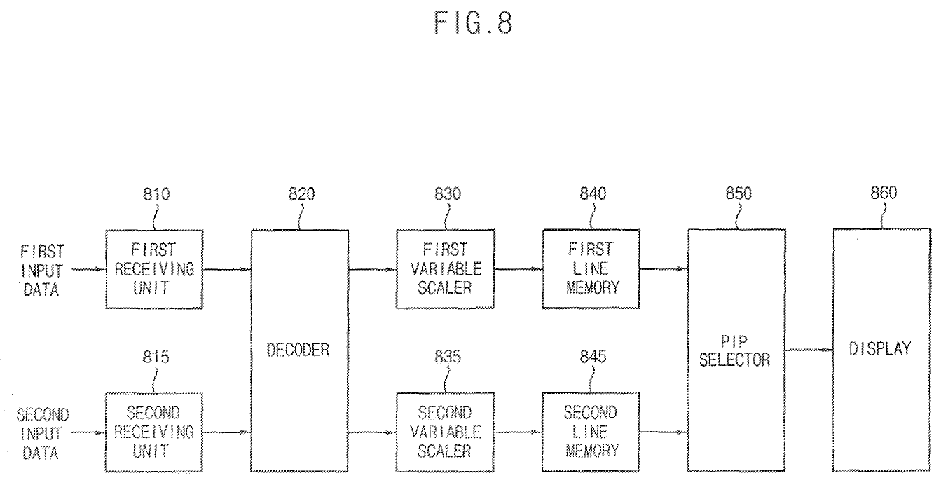

FIG. 8 is a block diagram illustrating a configuration of a digital TV performing a picture-in-picture (PIP) function according to an exemplary embodiment of the present invention.

Referring to FIG. 8, the digital TV performing the PIP function includes a first receiving unit 810, a second receiving unit 815, a decoder 820, a first variable scaler 830, a second variable scaler 835, a first line memory 840, a second line memory 850, a PIP selector 850 and a display 860.

The first receiving unit 810 selects a first channel from among a plurality of wired/wireless channels so as to receive a first digital video data through the first channel. For example, the wired/wireless channel may be formed by a cable, the Internet, satellite broadcasting, a terrestrial broadcasting, and the like.

The second receiving unit 815 selects a second channel from among a plurality of wired/wireless channels so as to receive a second digital video data through the second channel. The first channel received by the first receiving unit 810 and the second channel received by the second receiving unit 815 may be the same or may use a different transmission medium.

The same decoder 820 decodes the digital video data received by the first and second receiving units 810 and 815, because the received digital video data are generally encoded by the same predetermined method, such as a moving picture expert group (MPEG) standard.

The first variable scaler 830 outputs a first vertical sync signal (V-SYNC1), a first horizontal sync signal (H-SYNC1), a first vertical line active signal (V-ACTIVE1) and a first horizontal active signal (H-ACTIVE1) concerning the first received digital video data. The first digital video data may include a plurality of frames, each frame may include a plurality of lines, and each line may include a plurality of pixels. An output time of the first horizontal active signal (H-ACTIVE1) may be determined by a ratio of the number of pixels included in an input line to the number of pixels included in an output line, and a size of the line memory 840 for the line indicating a single horizontal line in a single video frame.

The second variable scaler 835 outputs a second vertical sync signal (V-SYNC2), a second horizontal sync signal (H-SYNC2), a second vertical line active signal (V-ACTIVE2) and a second horizontal active signal (H-ACTIVE2) concerning the received second digital video data. The second digital video data may include a plurality of frames, each frame may include a plurality of lines, and each line may include a plurality of pixels. An output time of the first horizontal active signal (H-ACTIVE1) may be determined by a ratio of the number of pixels included in an input line to the number of pixels included in an output line, and a size of the line memory 840 for the line indicating a single horizontal line in a single video frame.

A structure of each of the first and second variable scalers 840 and 845 may be the same as that of the variable scaler 330 in FIG. 3, respectively. Therefore, an operation of each of the first and second variable scalers 840 and 845 may be similar to that of the variable scaler 330 described above.

The first line memory 840 stores the first scaled digital video data outputted from the first variable scaler 830. The first variable scaler 830 writes the first digital video data into the first line memory 840 and the display 860 reads the written data from the first line memory 840.

The second line memory 845 stores the second scaled digital video data outputted from the second variable scaler 835. The second variable scaler 835 writes the second digital video data into the second line memory 845 and the display 860 reads the written data from the second line memory 845.

The PIP selector 850 selectively reads the first data from the first line memory 840 or the second data from the second line memory 845 That is, the PIP selector 850 selects one of the first and second data when the PIP selector 850 outputs a line of a frame to the display 860. The operation of the PIP selector 850 will be described hereinbelow.

The display 860 displays the data selected by the PIP selector 850. For example, when the PIP selector 850 selects the first data in the first line memory 840, the display 860 displays the first data stored in the first line memory 840.

The first variable scaler 830 adjusts an output time of the first horizontal active signal (H-ACTIVE1). Because there is a time difference between the time point that the first, variable scaler 830 writes the first data into the first line memory 840 and the time point that the PIP selector 850 reads the first written data from the first line memory 840, the size of the first line memory 840 may be reduced by adjusting an output time of the first horizontal active signal (H-ACTIVE1).

The second scaler 835 adjusts an outputting time of the second horizontal active signal (H-ACTIVE2). Because there is a time difference between the time point that the second variable scaler 835 writes the second data into the second Sine memory 845 and the time point that the PIP selector 850 reads the second written data from the second line memory 840, the size of the second line memory 840 may be reduced by adjusting an output time of the second horizontal active signal (H-ACTIVE2).

The output times of the first and second horizontal active signals (H-ACTIVE1, H-ACTIVE2) may be respectively determined as described above.

The output times of the first and second horizontal active signals (H-ACTIVE1, H-ACTIVE2) may be different, however, because the number of pixels in the first input/output horizontal lines is different from the number of pixels in the second input/output horizontal line.

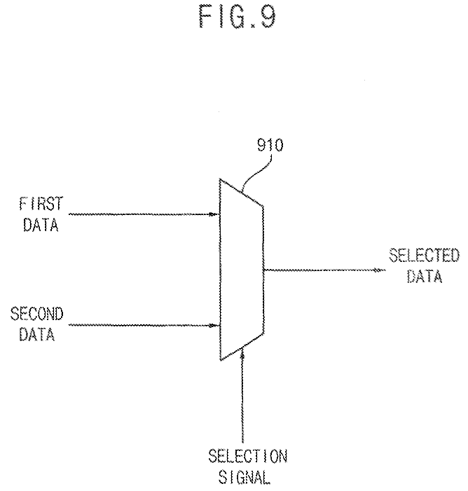

FIG. 9 is a block diagram illustrating the PIP selector 850 shown in FIG. 8.

Referring to FIG. 9, the PIP selector 850 includes a multiplexer 910.

The multiplexer 910 receives the first data outputted from the first line memory 830 and the second data outputted from the second line memory 835 to select one of the first and second data.

It is assumed that the first data corresponds to a main frame and the second data corresponds to a sub frame.

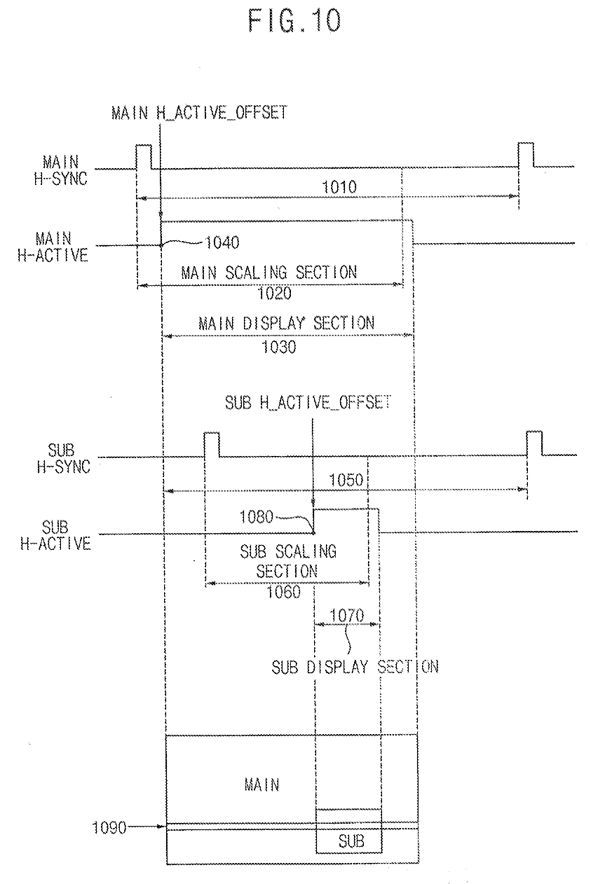

FIG. 10 is a timing diagram illustrating a procedure of outputting a single line of the main frame and the sub frame in the digital TV.

Referring to FIG. 10, a procedure of outputting a single line of the main frame by the first variable sealer 830 of FIG. 8 is divided into a main horizontal line section 1010, a main scaling section 1020, a main display section 1030 and an output time of the main horizontal active signal 1040. A procedure of outputting a single line of the sub frame is divided into a sub horizontal line section 1050, a sub scaling section 1060, a sub display section 1070 and an output time of the sub horizontal active signal 1080.

Hereinafter, the procedure of outputting the single line of the main frame and the sub frame in the digital TV is described.

In the main horizontal line section 1010, the display 860 shown in FIG. 8 outputs the single line of the main frame. The main horizontal sync signal (MAIN H_SYNC) indicates an end of a previous line and a start of a current line in the main frame.

The main scaling section 1020 is a section of which the main scaler 830 scales the single line of the main frame. That is, the main scaling section 1020 indicates a section of which the main scaler 830 writes the first data into the first line memory 840 (hereinafter, “main line memory 840”).

The main display section 1030 is a section of which the display 860 outputs the single line of the main frame. That is, the main display section 1030 is a section of which the display 860 reads the first written data from the main line memory 840.

The output time of the main horizontal active signal (MAIN_H_ACTIVE_OFFSET) 1040 indicates a time point that the address of the main fine memory 840 does not collide even when the main variable scaler 830 and the display 860 concurrently access the main line memory 840.

The sub horizontal line section 1050 is a section of which the display 860 outputs the single line of the sub frame. The sub horizontal sync signal (SUB H_SYNC) indicates an end of a previous line and a start of a current line in the sub frame.

The sub scaling section 1060 is a section of which the sub scaler 835 scales the single line of the sub frame. That is, the sub scaling section 1060 indicates a section of which the sub scaler 835 writes the second data into the second line memory 845 (hereinafter, “sub line memory 845”).

The sub display section 1070 is a section of which the display 860 outputs the single line of the sub frame. That is, the sub display section 1070 is a section of which the display 860 reads the second written data from the sub line memory 845.

The output time of the sub horizontal active signal (SUB_H_ACTIVE_OFFSET) 1080 indicates a time point that the address of the sub line memory 845 does not collide even when the sub variable scaler 835 and the display 860 concurrently access the sub line memory 845.

A procedure of outputting the single line 1090 by the main (first) and sub (second) variable scalers 830 and 835 is described as follow.

The main horizontal sync signal (MAIN H_SYNC) by the main variable scaler 830 notifies a start of the single line in the main frame to the display 860. Then the PIP selector 850 reads the first data from the main line memory 840 to transmit the first read data when the main horizontal active signal (MAIN H_SYNC) corresponds to a high level.

The sub horizontal sync signal (SUB H_SYNC) by the sub scaler 835 notifies a start of the single line in the sub frame to the display 860. Then the PIP selector 850 reads the second data from the sub line memory 845 to transmit the second read data when the sub horizontal active signal (SUB H_SYNC) corresponds to a high level.

The PIP selector 850 selects the second data of the sub scaler 835 when both the main horizontal active signal (MAIN H_ACTIVE) and the sub horizontal active signal (SUB H_ACTIVE) correspond to a high level. That is, the PIP selector 850 reads the second data from the sub line memory 835 to transmit the second read data when both the main horizontal active signal (MAIN H_ACTIVE) and the sub horizontal active signal (SUB H_ACTIVE) correspond to a high level.

As described above, the method and apparatus according to an exemplary embodiment of the present invention may reduce a Sine memory size by determining an output time of a horizontal active signal, and change a display resolution regardless of the line memory size.

Exemplary embodiments of the present invention being thus described, it will be obvious that the same may be varied in many ways. Such variations are not to be regarded as a departure from the spirit and scope of exemplary embodiments of the present invention, and all such modifications as would be obvious to one skilled in the art are intended to be included within the scope of the following claims.

What is claimed is:

1. A method of providing a horizontal active signal, comprising:
generating a horizontal active signal based on a line memory size and a time difference between a writing time that a variable scaler with a first operational clock frequency scales an original video frame and writes a line of the scaled video frame into a line memory and a reading time that a display device with a second operational clock frequency reads the written line of the scaled video frame from the line memory, so that a line memory address does not collide when the variable scaler and the display device concurrently access the line memory, the first operational clock frequency being greater than the second operational clock frequency; and
providing the generated horizontal active signal to the display device.

2. The method of claim 1, wherein generating the horizontal active signal comprises:
determining a scaling factor based on a number of pixels in a line of the original video frame and a number of pixels in the line of the scaled video frame;
generating the horizontal active signal at a predetermined system time when the scaling factor is less than or equal to 1; and
generating the horizontal active signal based on the scaling factor and the line memory size when the scaling factor is greater than 1.

3. The method of claim 2, wherein generating the horizontal active signal based on the scaling factor and the line memory size comprises:
calculating a scaler time by dividing a number of pixels in the line of the original video frame by the first operational clock frequency;
calculating a display time by dividing the number of pixels in the line of the scaled video frame by the second operational clock frequency;
calculating a time difference between the scaler time and the display time; and
generating the horizontal active signal based on a value by multiplying the time difference between the scaler time and the display time by the second operational clock frequency.

4. The method of claim 2, wherein generating the horizontal active signal based on the scaling factor and the line memory size comprises:
searching a database for a generation time of the horizontal active signal based on the scaling factor and the line memory size; and
generating the horizontal active signal at the generation time obtained in the step of searching.

5. A method of performing a picture-in-picture (PIP) function in a digital TV, comprising:
generating a first horizontal active signal based on a first line memory size and a time difference between a writing time that a first variable scaler with a first operational clock frequency scales a first original video frame and writes a line of the first scaled video frame into a first line memory and a reading time that a display device with a third operational clock frequency reads the written line of the first scaled video frame from the first line memory, so that a first line memory address does not collide when the first variable scaler and the display device concurrently access the first line memory, the first operational clock frequency being greater than the third operational clock frequency;
generating a second horizontal active signal based on a second line memory size and a time difference between a writing time that a second variable scaler with a second operational clock frequency scales a second original video frame and writes a line of the second scaled video frame into a second line memory and a reading time that a display device reads the written line of the second scaled video frame from the second line memory, so that, a second line memory address does not collide when the second variable scaler and the display device concurrently access the second line memory, the second operational clock frequency being greater than the third operational clock frequency; and
performing a PIP function based on the first horizontal active si anal and the second horizontal active signal.

6. The method of claim 5, wherein generating the first horizontal active signal comprises:
determining a first scaling factor based on a number of pixels in a line of the first original video frame and a number of pixels in the line of the first scaled video frame;
generating the first horizontal active signal at a predetermined system time when the first scaling factor is less than or equal to 1; and
generating the first horizontal active signal based on the first scaling factor and the first line memory size when the first scaling factor is greater than 1.

7. The method of claim 6, wherein generating the first horizontal active signal based on the first scaling factor and the first line memory size comprises:
calculating a first scaler time by dividing a number of pixels in the line of the first original video frame by the first operational clock frequency;
calculating a first display time by dividing the number of pixels in the line of the first scaled video frame by the third operational clock frequency;
calculating a time difference between the first scaler time and the first display time; and
generating the first horizontal active signal based on a value by multiplying the time difference between the first scaler time and the first display time by the third operational clock frequency.

8. The method of claim 6, wherein generating the first horizontal active signal based on the first scaling factor and the first line memory size comprises;
searching a first database for a generation time of the first horizontal active signal based on the first scaling factor and the first line memory size; and
generating the first horizontal active signal at the generation time obtained in the step of searching.

9. The method of claim 5, wherein generating the second horizontal active signal comprises:
determining a second scaling factor based on a number of pixels in a line of the second original video frame and a number of pixels in the Sine of the second scaled video frame;
generating the second horizontal active signal at a predetermined system time when the second scaling factor is less than or equal to 1; and
generating the second horizontal active signal based on the second scaling factor and the second line memory size when the second scaling factor is greater than 1.

10. The method of claim 9, wherein generating the second horizontal active signal based on the second scaling factor and the second line memory size comprises:
calculating a second scaler time by dividing a number of pixels in the line of the second original video frame by the second operational clock frequency;
calculating a second display time by dividing the number of pixels in the line of the second scaled video frame by the third operational clock frequency;
calculating a time difference between the second scaler time and the second display time; and
generating the second horizontal active signal based on a value obtained by multiplying the time difference between the second scaler time and the second display time by the third operational clock frequency.

11. The method of claim 9, wherein generating the second horizontal active signal based on the second scaling factor and the second line memory size comprises:
searching a second database for a generation time of the second horizontal active signal based on the second scaling factor and the second line memory size; and
generating the second horizontal active signal at the generation time obtained in the step of searching.

12. A digital TV, comprising:
a line memory configured to store a line of a scaled video frame;
a display device configured to read the line of the scaled video frame when the display device receives a horizontal active signal; and
a variable scaler configured to generate the horizontal active signal based on a line memory size and a time difference between a writing time that the variable scaler with a first operational clock frequency scales an original video frame and writes the line of the scaled video frame into the line memory and a reading time that the display device with a second operational clock frequency reads the written line of the scaled video frame from the line memory, so that a line memory address does not collide when the variable scaler and the display device concurrently access the line memory, the first operational clock frequency being greater than the second operational clock frequency.

13. The digital TV of claim 12, wherein the variable scaler determines a scaling factor based on a number of pixels in a line of the original video frame and a number of pixels in the line of the scaled video frame, generates the horizontal active signal at a predetermined system time when the scaling factor is less than or equal to 1, and generates the horizontal active signal based on the scaling factor and the line memory size when the scaling factor is greater than 1.

14. The digital TV of claim 13, wherein the variable scaler calculates a scaler time by dividing a number of pixels in the line of the original video frame by the first operational clock frequency, calculates a display time by dividing the number of pixels in the line of the scaled video frame by the second operational clock frequency, calculates a time difference between the scaler time and the display time, and generates the horizontal active signal based on a value by multiplying the time difference between the scaler time and the display time by the second operational clock frequency.

15. The digital TV of claim 13, wherein the variable scaler searches a database for a generation time of the horizontal active signal based on the scaling factor and the line memory size, and generates the horizontal active signal at the generation time obtained by the variable scaler.

16. The digital TV of claim 12, wherein the fine memory size is smaller than a memory size of storing the number of pixels in the line of the original video frame.

17. A digital TV performing a picture-in-picture (PIP) function, comprising:
a first line memory configured to store a line of a first scaled video frame;
a second line memory configured to store a line of a second scaled video frame:
a PIP selector configured to selectively read the line of the first scaled video frame or the line of the second scaled video frame based on a first horizontal active signal and a second horizontal active signal;
a display device configured to display the selected line;
a first variable scaler configured to generate the first horizontal active signal based on a first line memory size and a time difference between a writing time that the first variable scaler with a first operational clock frequency scales a first original video frame and writes the Sine of the first scaled video frame into the first line memory and a reading time that the display device with a third operational clock frequency reads the written line of the first scaled video frame from the first line memory, so that a first line memory address does not collide when the first variable scaler and the display device concurrently access the first line memory, the first operational clock frequency being greater than the third operational clock frequency; and
a second variable scaler configured to generate the second horizontal active signal based on a second line memory size and a time difference between a writing time that the second variable scaler with a second operational clock frequency scales a second original video frame and writes the line of the second scaled video frame into the second line memory and a reading time that the display device with the third operational clock frequency reads the written line of the second scaled video frame from the second line memory, so that a second line memory address does not collide when the second variable scaler and the display device concurrently access the second line memory, the second operational clock frequency being greater than the third operational clock frequency.

18. The digital TV of claim 17, wherein the first variable scaler determines a first scaling factor based on a number of pixels in a line of the first original video frame and a number of pixels in the line of the first scaled video frame, generates the first horizontal active signal at a predetermined system time when the first scaling factor is less than or equal to 1, and generates the first horizontal active signal based on the first scaling factor and the first line memory size when the first scaling factor is greater than 1.

19. The digital TV of claim 18, wherein the first variable scaler calculates a first scaler time by dividing a number of pixels in the line of the first original video frame by the first operational clock frequency, calculates a first, display time by dividing the number of pixels in the line of the first scaled video frame by the third operational clock frequency, calculates a time difference between the first scaler time and the first display time, and generates the first horizontal active signal based on a value obtained by multiplying the time difference between the first scaler time and the first display time by the third operational clock frequency.

20. The digital TV of claim 18, wherein the first variable scaler searches a first database for a generation time of the first horizontal active signal based on the first scaling factor and the first line memory size, and generates the first horizontal active signal at the generation time obtained by the first variable scaler.

21. The digital TV of claim 18, wherein the first line memory size is smaller than a memory size of storing the number of pixels in the line of the first original video frame.

22. The digital TV of claim 17, wherein the second variable scaler determines a second scaling factor based on a number of pixels in a line of the second original video frame and a number of pixels in the line of the second scaled video frame, generates the second horizontal active signal at a predetermined system time when the second scaling factor is less than or equal to 1, and generates the second horizontal active signal based on the second scaling factor and the second line memory size when the second scaling factor is greater than 1.

23. The digital TV of claim 22, wherein the second variable scaler calculates a second scaler time by dividing a number of pixels in the line of the second original video frame by the second operational clock frequency, calculates a second display time by dividing the number of pixels in the line of the second scaled video frame by the third operational clock frequency, calculates a time difference between the second scaler time and the second display time, and generates the second horizontal active signal based on a value obtained by multiplying the time difference between the second scaler time and the second display time by the third operational clock frequency.

24. The digital TV of claim 22, wherein the second variable scaler searches a second database for a generation time of the second horizontal active signal based on the second scaling factor and the second line memory size, and generates the second horizontal active signal at the generation time obtained by the second variable scaler.

25. The digital TV of claim 22, wherein the second line memory size is smaller than a memory size of storing the number of pixels in the line of the second original video frame.
